(19) United States
(12) Patent Application Publication
(10) Pub. No.: US 2004/0015961 A1
(43) Pub. Date: Jan. 22, 2004

(54) Method and apparatus for automatic prerequisite verification and installation of software

(75) Inventors: Thomas E. Chefalas, Somers, NY (US); Steven J. Mastrianni, Unionville, CT (US); Ajay Mohindra, Yorktown Heights, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/811,845

(22) Filed: Mar. 19, 2001

(51) Int. Cl. G06F 9/445; G06F 15/177

(52) U.S. Cl. 717/178; 709/221

(57) ABSTRACT

A technique for automatically installing software on one or more network-connected computer systems is disclosed. A user makes a request through a World Wide Web (WWW) site to install software on one or more computer systems. Software agents residing on the computer systems, under the direction of the server underlying the WWW site, collect installation information and install and configure the software.

### BACKGROUND OF THE INVENTION

1. Technical Field

The present invention relates generally to a method of installing software on a computer. More specifically, the present invention is directed toward a method of automatically downloading, installing, and configuring software on one or more target systems in a network.

2. Description of Related Art

Internet, also referred to as an “internetwork,” in communications is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies that must interact with virtually all segments of society such as the Internal Revenue Service and secretaries of state. Operating costs may be reduced by providing informational guides and/or searchable databases of public records online.

Currently, the most commonly employed method of transferring data over the Internet is to employ the World Wide Web environment, also called simply “the web.” Other Internet resources exist for transferring information, such as File Transfer Protocol (FTP) and Gopher, but have not achieved the popularity of the web. In the web environment, servers and clients effect data transaction using the Hypertext Transfer Protocol (HTTP), a known protocol for handling the transfer of various data files (e.g., text, still graphic images, audio, motion video, etc.). Information is formatted for presentation to a user by a standard page description language, the Hypertext Markup Language (HTML). In addition to basic presentation formatting, HTML allows developers to specify “links” to other web resources identified by a Uniform Resource Locator (URL). A URL is a special syntax identifier defining a communications path to specific information. Each logical block of information accessible to a client, called a “page” or a “web page,” is identified by a URL. The URL provides a universal, consistent method for finding and accessing this information by the web “browser.” A browser is a program capable of submitting a request for information identified by a URL at the client machine. Retrieval of information on the web is generally accomplished with an HTML-compatible browser, such as, for example, Netscape Communicator, which is available from Netscape Communications Corporation.

When a user desires to retrieve a document, such as a web page, a request is submitted to a server connected to a client computer at which the user is located and may be handled by a series of servers to effect retrieval of the requested information. The selection of a document is typically performed by the user selecting a hypertext link. The hypertext link is typically displayed by the browser on a client as a highlighted word or phrase within the document being viewed with the browser. The browser then issues a hypertext transfer protocol (HTTP) request for the requested documents to the server identified by the requested document's URL. The server then returns the requested document to the client browser using the HTTP. The information in the document is provided to the client in which the document is formatted according to HTML. Typically, browsers on personal computers (PCs) along with workstations are used to access the Internet. The standard HTML syntax of Web pages and the standard communication protocol (HTTP) supported by the World Wide Web guarantee that any browser can communicate with any web server.

In addition to providing a medium for transmitting documents as hypertext, the World Wide Web can also function as a user interface to a remote computer system. For instance, some retail web sites, such as “amazon.com” provide an interface to a product-ordering system, so that customers can order products online. Other websites, such as “download.com,” allow users to download program files to install onto their computer systems.

Once a program has been downloaded from a website, however, it must usually be installed in some fashion. Installation of a computer program refers to a process of preparing the program to be executed on a particular computer system. Program installation may include such steps as decompressing or copying files and setting configuration options. Before installing a program, a user must verify that all hardware and software prerequisites for the program are available on the target computer. If these prerequisites are not available then a user must install the necessary prerequisites prior to installing the program. If either the prerequisites are not properly installed or the steps for program installation are not performed properly, the program will not execute properly. Depending of the complexity of the program in question, the installation process may be quite involved. This is particularly true of software that must be installed on a large number of computers, such as an institutional network of computers.

What is needed, then, is a technique for simplifying the installation of downloaded software on one or more computer systems.

### SUMMARY OF THE INVENTION

The present invention provides a technique for automatically installing software on one or more network-connected computer systems. A user submits a request to a server through a web-based interface. In response to the request, the server schedules an installation of the software. At the appropriate time, agents residing on the installation target computers collect information about the target computers. This information is used to download and install the proper version of the software, as well as any prerequisite software packages to be installed with the software. The agents then use the collected information to set configuration options for the installed software. When the agents complete their task, a confirmation message is relayed to the user via electronic mail or other means such as telephone or pager.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an overview of a hardware configuration in accordance with an embodiment of the present invention;

FIG. 2 is an overview of the process of software installation performed by an embodiment of the present invention;

FIG. 3 is a diagram of a website in accordance with an embodiment of the present invention;

FIG. 4 is a diagram of a login page of a website in accordance with an embodiment of the present invention;

FIG. 5 is a diagram of a menu page for selecting a software title from a website in accordance with an embodiment of the present invention;

FIG. 6 is a diagram of a product description page of a website in accordance with an embodiment of the present invention;

FIG. 7 is a diagram of a menu page for selecting target computers from a website in accordance with an embodiment of the present invention;

FIG. 8 is a diagram of a installation agent download page from a website in accordance with an embodiment of the present invention;

FIG. 9 is a flowchart representation of the operation of a server receiving customer requests in accordance with an embodiment of the present invention;

FIG. 10 is a flowchart representation of the operation of a server directing a scheduled installation process in accordance with an embodiment of the present invention; and

FIG. 11 is a flowchart representation of the operation of a software installation agent in accordance with an embodiment of the present invention.

### DETAILED DESCRIPTION OF THE PREFERRED EMBODIMENT

FIG. 1 depicts an overview of a collection 100 of computer systems connected to an Internet 105 and configured to operate in accordance with an embodiment of the present invention. Client computer 110, under the direction of a user, enters into communication with server 120 through Internet 105. Alternatively, a wireless network, local area network, wide area network, intranet, or any other form of computer network could be substituted for Internet 105. Client computer 110 submits a request to server 120 that a particular item of software be installed on target computers 130, 132, and 134. Server 120, after receiving the request, schedules a time for installing the desired software on target computers 130, 132, and 134. A convenient time might be one very early in the morning, when most of target computers 130, 132, and 134 will likely not be in use.

At such scheduled time, server 120 or an alternate server 122 enters into communication with target computers 130, 132, and 134 and commences a verification process on each of target computers 130, 132, and 134. The verification process determines whether target computers 130, 132, and 134 are capable of executing the desired software. The verification process also determines which version or versions of the software should be installed on each of target computers 130, 132, and 134, what prerequisite software packages must be installed before installing the desired software, and how each copy of the software should be configured to operate on the its respective target computer.

After the verification process has ended, the software and its prerequisite software packages are installed and configured on target computers 130, 132, and 134. After the software has been installed or has been determined to be un-installable on each of target computers 130, 132, and 134, confirmation messages are sent from target computers 130, 132, and 134 back to server 120 or alternate server 122. Finally, server 120 or the alternative server sends a confirmation message to the user of client computer 110 through electronic mail (E-mail).

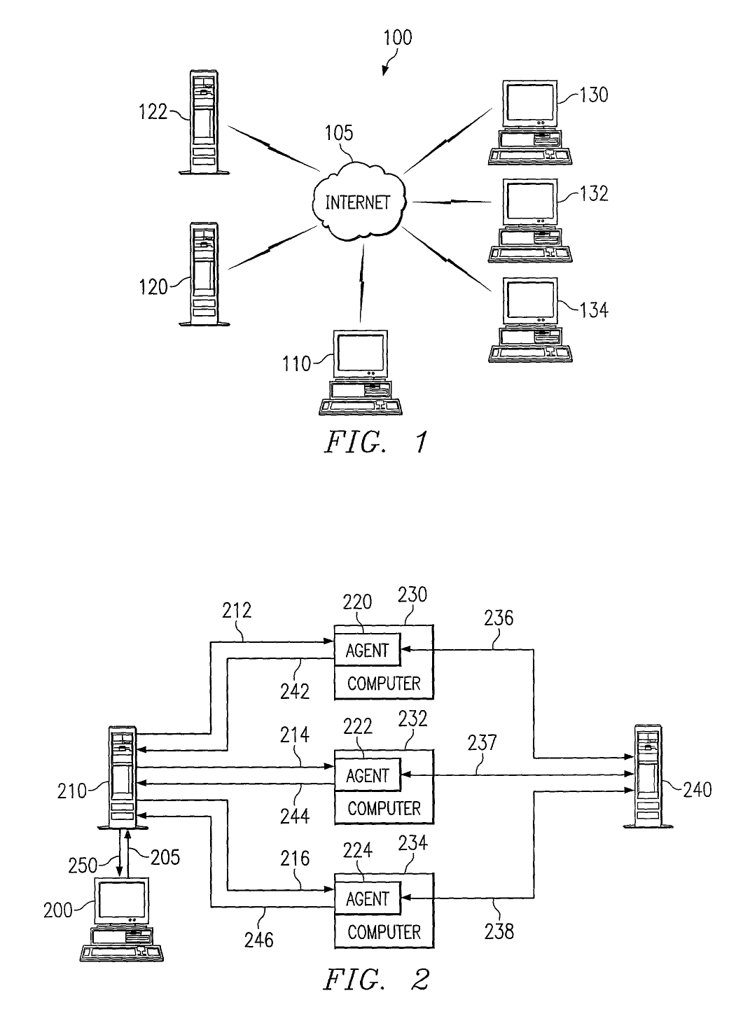

FIG. 2 provides a more detailed view of the overall operation of an embodiment of the present invention. Client computer 200 sends a request 205 to server 210 to install an item of software on target computers 230, 232, and 234. Although not depicted in FIG. 2, the target computers may include client computer 200.

Server 210, at a scheduled time, sends instructions 212, 214, and 216 to target computers 230, 232, and 234. Instructions 212, 214, and 216 are received by software agents 220, 222, and 224, which execute on target computers 230, 232, and 234. Instructions 212, 214, and 216 include information such as what software is to be installed, what the hardware and software prerequisites are for that piece of software, and rules for determining how configuration options should be set for the software.

After receiving instructions 212, 214, and 216, agents 220, 222, and 224 enter into contact with an installation server 240 (which may or may not be the same server as server 210). Agents 220, 222, and 224 collect information that is pertinent to determining whether the software to be installed may be installed and how the software should be installed and configured. In addition, agents 220, 222, and 224 collect information concerning which prerequisite software packages must be installed prior to installing the desired software.

In one possible embodiment, after the information is collected, agents 220, 222, and 224 make a determination as to what version of the software should be installed, what prerequisites are needed to be installed, and how the software should be configured. In an alternative embodiment, the collected information is forwarded to server 240, and server 240 makes the determinations as to versions, prerequisites, and configuration.

After determinations have been made as to versions, prerequisites and configuration, agents 220, 222, and 224 download (236, 237, and 238) and install the desired software and any prerequisite software packages onto target computers 230, 232, and 234. Agents 220, 222, and 224 then configure the installed software to operate properly on target computers 230, 232, and 234.

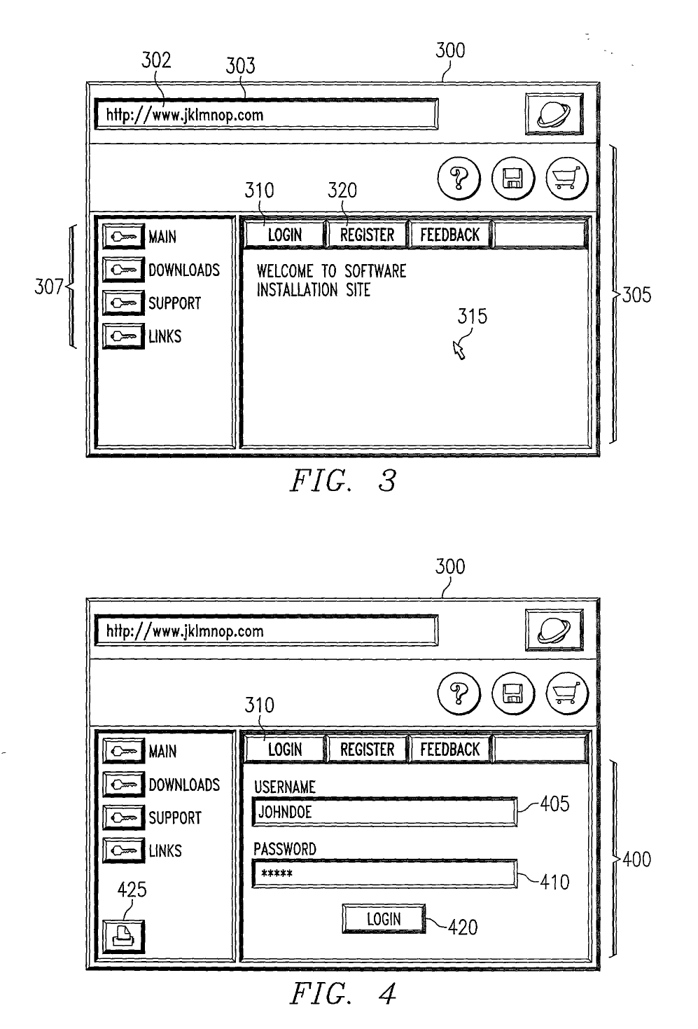

FIG. 3 demonstrates how a user interface for an embodiment of the present invention may be implemented through an HTML browser window 300. Users can initiate communication with a server, such as 120 in FIG. 1, by entering a uniform resource locator (URL) 302 corresponding to the server into the address entry form 303 at the top of the browser window 300. The main interface is contained in HTML page 305 displayed within browser window 300, which is loaded from the server. HTML page 305 contains a set of navigational controls 307 to allow the user to move from one displayed HTML page to another.

In this particular embodiment, a “login” control 310 and a “register” control 320 are defined. Login control 310, when clicked with mouse pointer 315 (using a mouse or similar pointing device), allows a user to access a user account, which may store data about the user's computer systems. This feature allows a user to conveniently install software for an entire network of computers without having to re-identify each computer individually to the server each time. Register control 320 allows a new user of the server to establish a new user account.

In FIG. 4, when login control 310 is clicked, login page 400 is displayed. The user is prompted to enter a user name in a “username” text field 405. The user is also prompted to enter a password in a “password” text field 410. Requiring both a user name and password protects potentially sensitive information about the user's computer systems from discovery by others. To complete the login process, the user clicks on button 420. Added security protection is provided through encryption of the data transmitted between the user's client computer and the server. This can be accomplished through the use of Secure Sockets Layer (SSL) technology, which is available in most commonly-used HTML browsers today. A locked padlock icon 425 in the lower-left corner of browser window 300 signifies that encryption is being used.

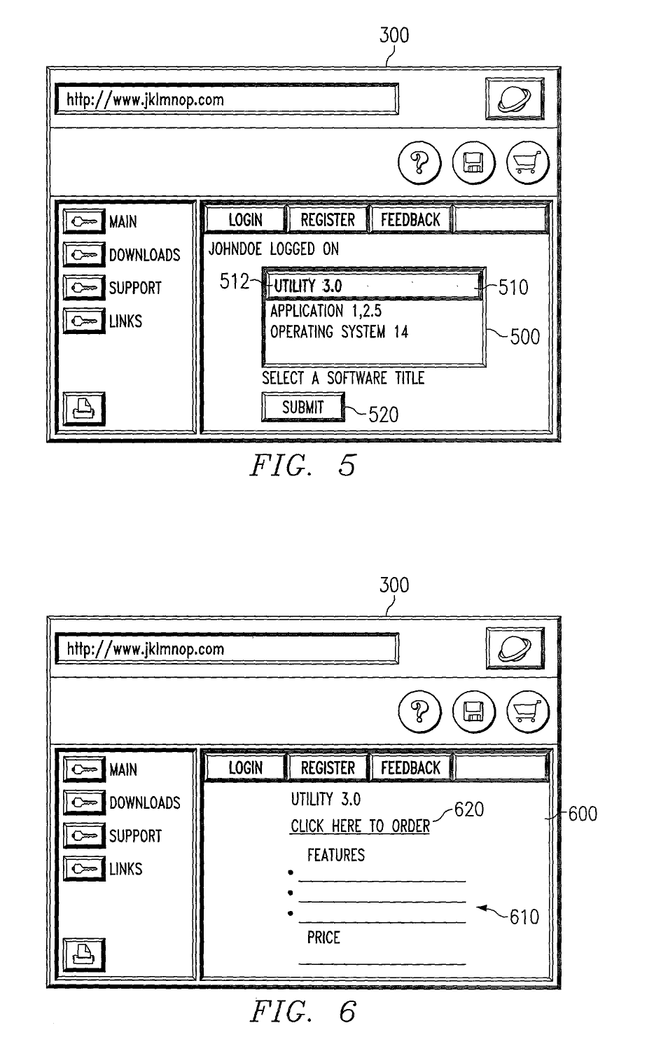

In FIG. 5, after the user has logged in, the user may select from a menu 500 an item of software to be previewed or installed. The user highlights a choice 510 by clicking on choice 512 with the mouse or other pointing device. The user then clicks a submit button 520 to continue. In an alternative embodiment, more than one software title may be selected.

In FIG. 6, after an appropriate title has been selected, a preview page 600 is displayed within browser window 300. The preview page provides information about the software 610 and an ordering link 620. When the user clicks on link 620 with the mouse or other pointing device, the user signifies that the program in question is to be installed on one or more of the user's computer systems.

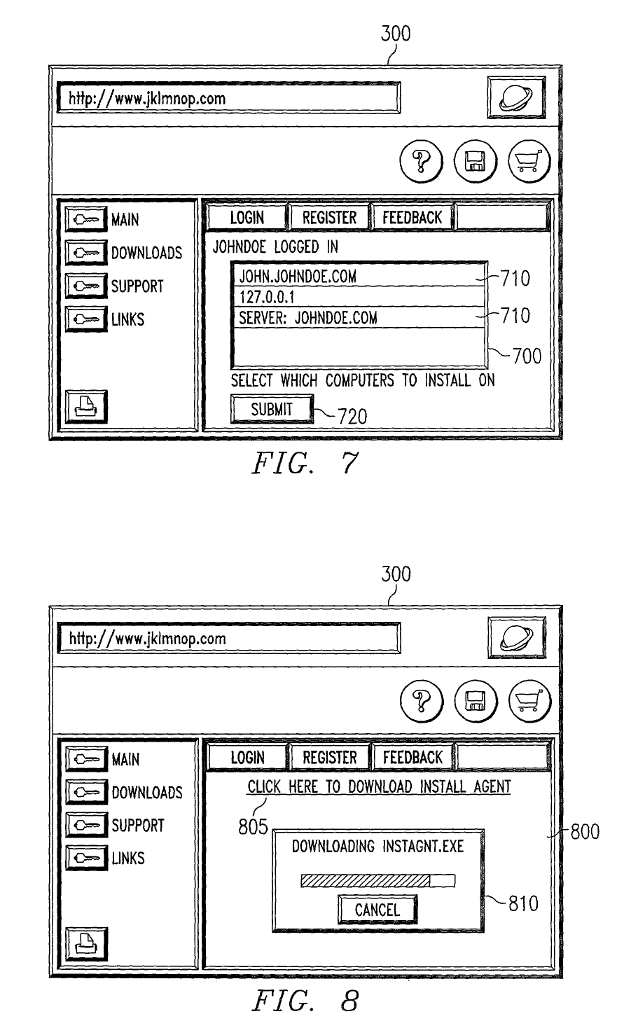

In FIG. 7, after the user has opted to install the item of software, the user is given an opportunity to specify which target computers the software should be installed on. Because the user in FIG. 7 has already logged into the user's account, a menu 700 of computers owned or under the control of the user is displayed. In an alternative embodiment or in the case that a user has not logged in, the user may be prompted to provide identifying information about the computer onto which the software is to be installed, rather being provided with a menu of choices. In the embodiment in FIG. 7, however, the user selects the proper target computers by clicking on appropriate choices 710 to highlight them, then clicking submit button 720 to complete the choice. After the user clicks submit button 720, the server will schedule an appropriate time to install the software.

In order for the software to be installed on the selected target computers, installation agents must be present and installed on each of the target computers. FIG. 8 demonstrates that such installation agents may be downloaded using an interface provided by an HTML page 800, then easily installed by a user. HTML page 800 contains a link 805 that, when clicked, begins the process of downloading an executable file containing the installation agent. Status window 810 displays the status of the installation agent executable file that is being downloaded. Once download is complete, the user may execute the executable file to enable the installation agent.

A more convenient alternative to downloading an installation agent would be to bundle the installation agent with some other piece of software, such as an operating system, so that any computer with the other piece of software installed would also have the installation agent installed. This alternative is particularly useful in the context of technical support, where updates to software products must be distributed to users who already have the original product installed.

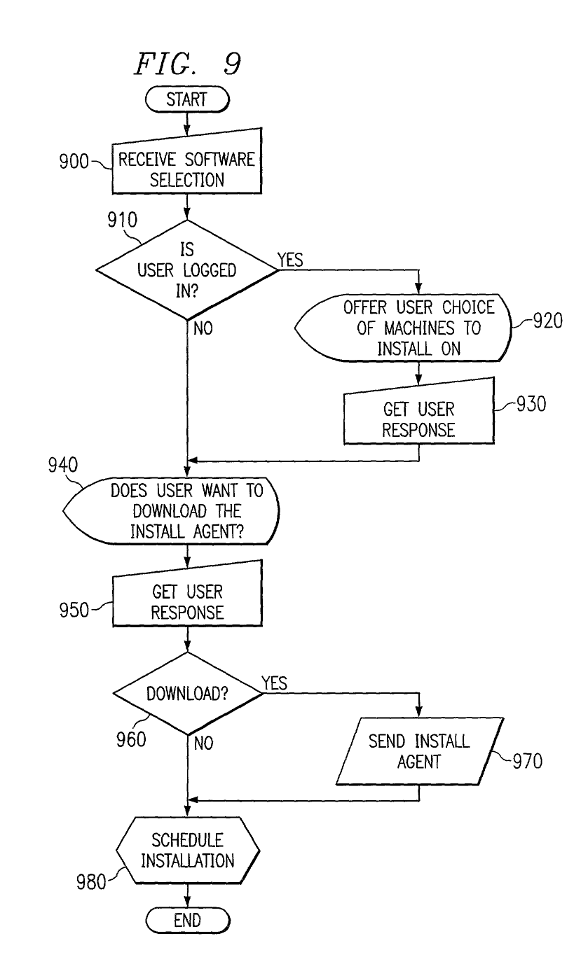

FIG. 9 is a flowchart representation of the operation of a server in receiving and processing a request from a client computer, in accordance with an embodiment of the present invention. First the server receives the user's choice as to which software is to be installed (step 900). If the user is logged into a user account, so that information stored on the server about the user's computer systems is available (step 910), the user is given a list of choices as to which target computers to install the software on (step 920). The server then receives the user's choices (step 930).

Next, the user is given the option of downloading the installation agent to install on the target computers prior to downloading (step 940). The user's choice is then received by the server (step 950). If the user has opted to download the installation agent (step 960), then the installation agent is transmitted to the user's client computer (step 970). Finally, the installation is scheduled (step 980).

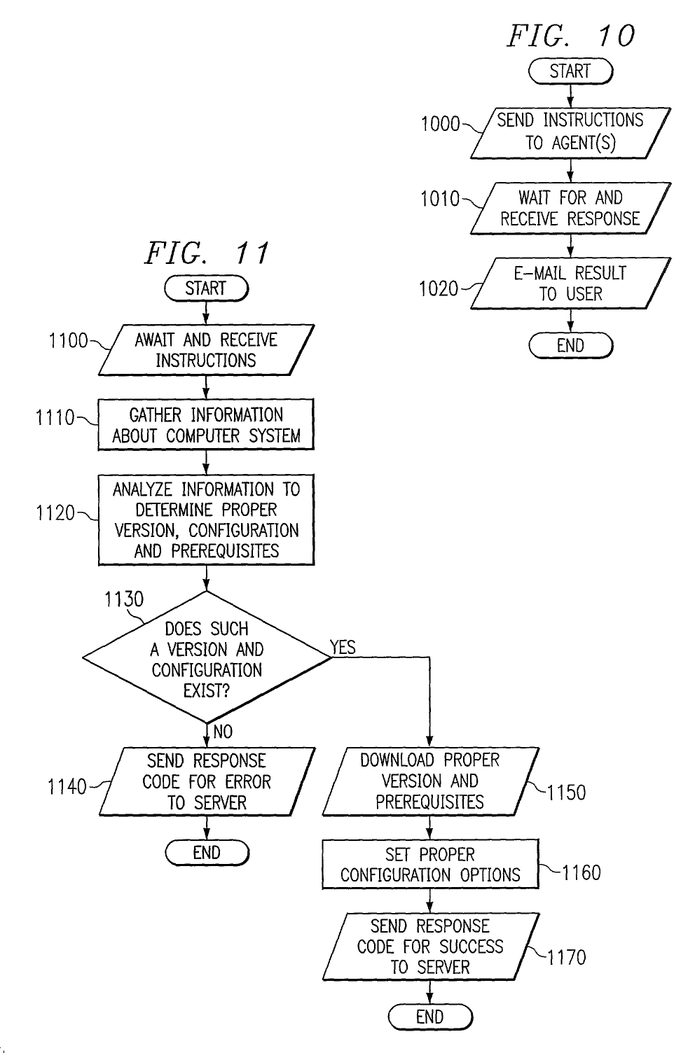

FIG. 10 is a flowchart representation of a server in the process of performing a scheduled installation. First instructions concerning the installation to be performed are sent to the installation agent or agents on the target computer(s) (step 1000). Next, the server awaits and receives a response (positive or negative) from each of the target computers (step 1010). Finally, a confirmation is sent to a user through electronic mail (E-mail) (step 1020). Alternatively, the confirmation could be sent via some other communication means, such as by telephone or pager.

FIG. 11 is a flowchart representation of the operation of an installation agent written in accordance with an embodiment of the present invention. First, the agent awaits and receives instructions from a server (step 1100). Pursuant to the instructions, the agent gathers information pertinent to determining the proper version, configuration, and prerequisites (step 1120). Next, the agent determines whether a combination of software version, configuration, and installed prerequisites exists such that the desired software can be installed (step 1130). If not, then a response is sent to the server indicating that installation is impossible (step 1140).

If the software can be installed, then the proper version of the software and the necessary prerequisite software components are downloaded from the server (step 1150). Next, the proper configuration options for the software are set (step 1160). Finally, the agent sends a response back to the server to indicate that installation was successful (step 1170).

One of ordinary skill in the art will appreciate that the present invention is applicable in a number of application domains. One such domain, which was mentioned earlier in passing, is as a distribution means for technical support updates to software. Both application and system software products are oftentimes updated frequently, and the ability to make automatic updates in the manner here described is a tremendous convenience.

Another application domain to which the technology of the present invention is particularly well suited is that of a World-Wide Web based online software store. The installation server and agent system of the present invention can be coupled to an additional hardware/software system for obtaining payment. The installation server, in such an instance, can charge a user's credit card account or bank account when a successful installation has been performed, and when the installation is not successful, it is possible to allow no charges to accrue. In this way, a customer only pays for what the customer actually receives.

One of ordinary skill in the art will also appreciate that in an embodiment of the present invention, multiple items may ordered for installation at once. The present invention is not limited to installing one item of software at a time. In addition, the commonly used World Wide Web technique of providing users with an online “shopping cart,” so that multiple products may be selected one-by-one while browsing, then ordered together at one time, is also applicable to the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for automatically downloading and installing software to a computer system, comprising the steps of:
receiving an instruction to install an item of software on the computer system;
collecting data about the computer system to form collected data;
based on the collected data, downloading a proper version of the item of software from a server;
installing the proper version; and
based on the collected data, setting configuration options associated with the proper version.

2. The method of claim 1, further comprising the additional step of:
based on the collected data, determining whether the item of software can be installed on the computer system, and if the item of software cannot, then ending execution of the method.

3. The method of claim 1, further comprising the additional steps of:
submitting the collected data to a server; and
receiving an analysis of the collected data, wherein the analysis specifies the proper version and the configuration options.

4. The method of claim 1, further comprising the additional step of:
analyzing the collected data to determine the proper version and the configuration options.

5. The method of claim 1, further comprising the additional step of:
returning a confirmatory message.

6. The method of claim 1, wherein the receiving step includes a step of receiving the instruction via one of a wireless network, a local area network, an Internet, an intranet, and a wide area network.

7. A method for automatically installing software on at least one computer system connected to a network, comprising the steps of:
receiving an instruction from a user input to install an item of software on the at least one computer system;
directing at least one software installation agent executing on the at least one computer system to download, install, and configure the item of software on the at least one computer system.

8. The method of claim 7, wherein the method is executed on a server.

9. The method of claim 7, further comprising the additional step of:
receiving at least one confirmatory message from the at least one software installation agent.

10. The method of claim 7, wherein the receiving step includes a step of receiving the instruction from a remote computing device via the network.

11. The method of claim 10, wherein the receiving step includes a step of receiving the instruction through a HyperText Markup Language (HTML) interface.

12. The method of claim 7, wherein the network includes at least one of a wireless network, a local area network, an Internet, an intranet, and a wide area network.

13. The method of claim 7, further comprising the additional step of:
based on the user input, choosing the at least one computer system from a stored inventory of computer systems.

14. The method of claim 7, further comprising the additional step of:
transmitting the at least one software installation agent to the at least one computer system to be installed by a user.

15. A computer program product, in a computer-readable medium, for automatically downloading and installing software to a computer system, comprising instructions for:
receiving an instruction to install an item of software on the computer system;
collecting data about the computer system to form collected data;
based on the collected data, downloading a proper version of the item of software from a server;
installing the proper version; and
based on the collected data, setting configuration options associated with the proper version.

16. The computer program product of claim 15, further comprising additional instructions for:
based on the collected data, determining whether the item of software can be installed on the computer system, and if the item of software cannot, then ending execution of the method.

17. The computer program product of claim 15, further comprising additional instructions for:
submitting the collected data to a server; and
receiving an analysis of the collected data, wherein the analysis specifies the proper version and the configuration options.

18. The computer program product of claim 15, further comprising additional instructions for:
analyzing the collected data to determine the proper version and the configuration options.

19. The computer program product of claim 15, further comprising additional instructions for:
returning a confirmatory message.

20. The computer program product of claim 15, wherein the instructions for receiving include instructions for receiving the instruction via one of a wireless network, a local area network, an Internet, an intranet, and a wide area network.

21. A computer program product, in a computer-readable medium, for automatically installing software on at least one computer system connected to a network, comprising instructions for:
receiving an instruction from a user input to install an item of software on the at least one computer system;
directing at least one software installation agent executing on the at least one computer system to download, install, and configure the item of software on the at least one computer system.

22. The computer program product of claim 21, wherein the computer program product is executed on a server.

23. The computer program product of claim 21, further comprising additional instructions for:
receiving at least one confirmatory message from the at least one software installation agent.

24. The computer program product of claim 21, wherein the instructions for receiving include instructions for receiving the instruction from a remote computing device via the network.

25. The computer program product of claim 24, wherein the instructions for receiving include instructions for receiving the instruction through a HyperText Markup Language (HTML) interface.

26. The computer program product of claim 21, wherein the network includes at least one of a wireless network, a local area network, an Internet, an intranet, and a wide area network.

27. The computer program product of claim 21, further comprising additional instructions for:
based on the user input, choosing the at least one computer system from a stored inventory of computer systems.

28. The computer program product of claim 21, further comprising additional instructions for:
transmitting the at least one software installation agent to the at least one computer system to be installed by a user.

29. A system for for automatically installing software, comprising:
a network;
a server connected to the network;
a client computer connected to the network; and
at least one target computer connected to the network, wherein each of the at least one target computer executes a software installation agent,
wherein the client computer submits a request to the server, responsive to receiving the request the server schedules an appropriate time to install an item of software, at the appropriate time the server notifies the software installation agent on each of the at least one target computer that the item of software is to be installed, the software agent on each of the at least one target computer collects data about the at least one target computer to make a determination if and how the item of software can be installed and configured, based on the determination the software installation agent on each of the at least one target computer downloads, installs, and configures the item of software on each of the at least one target computer.

30. The system of claim 29, wherein the network includes at least one of a wireless network, a local area network, an Internet, an intranet, and a wide area network.

31. The system of claim 29, wherein the determination is made by the server.

32. The system of claim 29, wherein the determination is made by the software installation agent.

33. The system of claim 29, wherein the client computer submits the request using a HyperText Transfer Protocol (HTTP).

34. An apparatus for automatically downloading and installing software to a computer system, comprising means for:
receiving an instruction to install an item of software on the computer system;
collecting data about the computer system to form collected data;
based on the collected data, downloading a proper version of the item of software from a server;
installing the proper version; and
based on the collected data, setting configuration options associated with the proper version.

35. The apparatus of claim 34, further comprising additional means for:
based on the collected data, determining whether the item of software can be installed on the computer system, and if the item of software cannot, then ending an operation of the apparatus.

36. The apparatus of claim 34, further comprising additional means for:
submitting the collected data to a server; and
receiving an analysis of the collected data, wherein the analysis specifies the proper version and the configuration options.

37. The apparatus of claim 34, further comprising additional means for:
analyzing the collected data to determine the proper version and the configuration options.

38. The apparatus of claim 34, further comprising additional means for:
returning a confirmatory message.

39. The apparatus of claim 34, wherein the instruction is received through one of a wireless network, a local area network, an Internet, an intranet, and a wide area network.

40. An apparatus for automatically installing software on at least one computer system connected to a network, comprising means for:
receiving an instruction from a user input to install an item of software on the at least one computer system;
directing at least one software installation agent executing on the at least one computer system to download, install, and configure the item of software on the at least one computer system.

41. The apparatus of claim 40, wherein the apparatus includes a server.

42. The apparatus of claim 40, further comprising additional means for:
receiving at least one confirmatory message from the at least one software installation agent.

43. The apparatus of claim 40, wherein the instruction is received from a remote computing device via the network.

44. The apparatus of claim 43, wherein the instruction is received through a HyperText Markup Language (HTML) interface.

45. The apparatus of claim 40, wherein the network includes at least one of a wireless network, a local area network, an Internet, an intranet, and a wide area network.

46. The apparatus of claim 40, wherein the user input chooses the at least one computer system from a stored inventory of computer systems.

47. The apparatus of claim 40, further comprising additional means for:
transmitting the at least one software installation agent to the at least one computer system to be installed by a user.

48. A data processing system comprising:
a bus system;
a communication unit connected to the bus system;
a memory connected to the bus system, wherein the memory includes a set of instructions; and
a processing unit, wherein the processing unit includes at least one processor,
wherein the processing unit executes the set of instructions to perform the acts of:
receiving an instruction to install an item of software on the data processing system;
collecting data about the data processing system to form collected data;
based on the collected data, downloading a proper version of the item of software from a server;
installing the proper version; and
based on the collected data, setting configuration options associated with the proper version.

49. The data processing system of claim 48, wherein the processing unit executes the set of instructions to perform the additional acts of:
based on the collected data, determining whether the item of software can be installed on the data processing system, and if the item of software cannot, then ending execution of the set of instructions.

50. The data processing system of claim 48, wherein the processing unit executes the set of instructions to perform the additional acts of:
submitting the collected data to a server; and
receiving an analysis of the collected data, wherein the analysis specifies the proper version and the configuration options.

51. The data processing system of claim 48, wherein the processing unit executes the set of instructions to perform the additional acts of:
analyzing the collected data to determine the proper version and the configuration options.

52. The data processing system of claim 48, wherein the processing unit executes the set of instructions to perform the additional acts of:
returning a confirmatory message.

53. The data processing system of claim 48, wherein the instruction is received through one of a wireless network, a local area network, an Internet, an intranet, and a wide area network.

54. A data processing system comprising:
a bus system;
a communication unit connected to the bus system;
a memory connected to the bus system, wherein the memory a set of instructions; and
a processing unit, wherein the processing unit includes at least one processor,
wherein the processing unit executes the set of instructions to perform the acts of:
receiving an instruction from a user input to install an item of software on the at least one data processing system;
directing at least one software installation agent executing on the at least one data processing system to download, install, and configure the item of software on the at least one data processing system.

55. The data processing system of claim 54, wherein the data processing system is a server.

56. The data processing system of claim 54, wherein the processing unit executes the set of instructions to perform the acts of:
receiving at least one confirmatory message from the at least one software installation agent.

57. The data processing system of claim 54, wherein the instruction is received from a remote computing device via the network.

58. The data processing system of claim 57, wherein the instruction is received through a HyperText Markup Language (HTML) interface.

59. The data processing system of claim 54, wherein the network includes at least one of a wireless network, a local area network, an Internet, an intranet, and a wide area network.

60. The data processing system of claim 54, wherein the user input chooses the at least one data processing system from a stored inventory of data processing systems.

61. The data processing system of claim 54, wherein the processing unit executes the set of instructions to perform the acts of:
transmitting the at least one software installation agent to the at least one data processing system to be installed by a user.
